(19) United States
(12) Patent Application Publication
(10) Pub. No.: US 2025/0182174 A1
(43) Pub. Date: Jun. 5, 2025

(54) FEATURE OR OFFER ASSOCIATED WITH PRINTING DEVICE CONSUMABLE ITEM

(71) Applicant: Hewlett-Packard Development Company, L.P., Spring, TX (US)

(72) Inventors: Gabriel Scott McDaniel, Boise, ID (US); Justin Pettingill, Boise, ID (US); Paul L Jeran, Boise, ID (US); Jeffrey H. Luke, Boise, ID (US)

(21) Appl. No.: 18/833,904

(22) PCT Filed: Jan. 31, 2022
(86) PCT No.: PCT/US2022/014496

§ 371 Date: Jul. 28, 2024

(51) Int. Cl. G06Q 30/0601; B29C 64/393; B33Y 50/02; B41J 2/175; B41J 3/46; G03G 15/00; G03G 15/08; G06V 20/20

(52) U.S. Cl. CPC G06Q 30/0611; B29C 64/393; B33Y 50/02; B41J 2/17543; B41J 3/46; G03G 15/0863; G03G 15/5016; G06V 20/20

(57) ABSTRACT

An identifier of a printing device consumable item captured by a user device is received from the user device. A feature associated with the consumable item or an offer associated with the consumable item is identified. The feature or the offer is transmitted to the user device for display on the user device. Acceptance of the feature or the offer is received. In response to receiving the acceptance of the feature or the offer, the feature is turned on or the offer is fulfilled.

### BACKGROUND

Printing devices can use a variety of different technologies to form images on media such as paper or to build three-dimensional (3D) objects. Such technologies include dry electrophotography (EP) and liquid EP (LEP) technologies, which may be considered as different types of laser and light-emitting diode (LED) printing technologies, as well as inkjet-printing technologies and three-dimensional (3D) printing technologies. Printing devices deposit print material, such as colorant like toner, ink (which can include other printing fluids or material as well), or 3D print material.

### BRIEF DESCRIPTION OF THE DRAWINGS

FIG. 1 is a diagram of an example system in which a feature or offer can be associated with a consumable item for a printing device.

FIG. 2 is a flowchart of an example method for turning on a feature associated with a consumable item for a printing device.

FIGS. 3A and 3B are flowcharts of different example methods for enabling a feature associated with a consumable item within a printing device, which can be used in conjunction with the method of FIG. 2.

FIG. 4 is a flowchart of an example method for fulling an offer associated with a consumable item for a printing device.

### DETAILED DESCRIPTION

As noted in the background, printing devices deposit print material to form images on media or, in the case of three-dimensional (3D) printing devices, to additively build (3D) objects. A printing device can include a cartridge of print material that the device uses for printing. As the printing device prints print jobs, print material is consumed from the cartridge. When the cartridge is empty or is running low on print material, the cartridge may be replaced with a replacement cartridge that has a fresh (e.g., full) supply of print material. A cartridge is thus one type of a consumable item that a printing device uses for printing. Other examples include fuser assemblies, developer assemblies, and so on, in the case of a laser-printing device, and fluid-ejection (e.g., inkjet) printheads in the case of a fluid-ejection (e.g., inkjet) device that employs separately replaceable printheads and fluid (e.g., ink) supplies.

Once a manufacturer of a consumable item has fabricated and packaged the consumable item in packaging (e.g., a box), the consumable item is in a state in which no further enhancements can be added to the item. A user may purchase the consumable item at a store, or otherwise acquire the consumable item. The user installs the consumable item in a compatible printing device when needed, and the printing device then uses the consumable item for printing. The features associated with the consumable item are thus fixed at time of packaging. For example, a replacement toner or ink cartridge includes a set amount of toner or ink, and the ability to print using this amount of toner or ink is the sole feature associated with the cartridge once the cartridge has been manufactured and packaged.

Techniques described herein, by comparison, provide for a feature associated with a printing device consumable item even after the consumable item has been manufactured and packaged. A user scans an identifier of a consumable item using a user device like a smartphone or other device. The user device transmits the identifier to a computing device, such as a server computer operated by or on behalf of the manufacturer of the consumable item. The computing device identifies a feature associated with the consumable item at that time, and transmits the feature to the user device. If the user accepts the feature, such as by purchasing the feature as one example, such acceptance is transmitted to the computing device by the user device, and the computing device turns on the feature. For example, a printing device may be instructed to enable the feature.

In this way, features can be associated with printing device consumable items after manufacture and packaging. A user may scan the code prior to purchase of the consumable item, at time of purchase of the item, or after having purchased the consumable item. The feature associated with the consumable item thus can provide extra value to the user. Because the feature is not identified until the code is scanned, the feature provides a post-manufacture and post-packaging enhancement to the printing device consumable item. The feature can extend the functionality of the consumable item when installed in and during usage by a printing device, or the functionality of one or multiple printing devices of the user regardless of the printing device in which the consumable item is installed.

Techniques described herein can also provide for an offer associated with a printing device consumable item prior to purchase. As before, a user scans an identifier of a consumable item using a user device, which transmits the identifier to a computing device that identifies the offer to provide to the user, based on various parameters and in one implementation via machine learning. The offer is transmitted to the user device, and the user has the opportunity to accept the offer by redeeming the offer when purchasing the consumable item. Therefore, a user can be swayed to purchase the consumable item with a targeted offer provided at the time that the user is considering purchase, such as when the user is in a store and has indicated such purchase consideration via scanning the identifier.

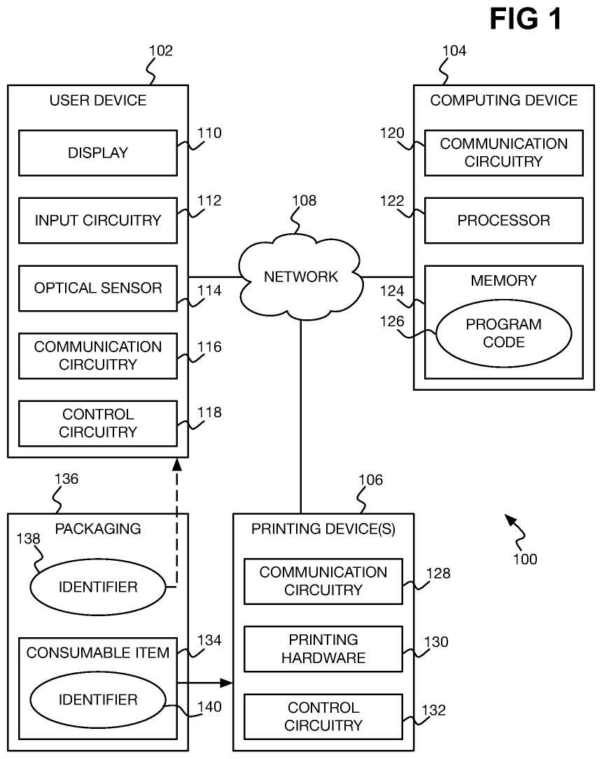

FIG. 1 shows an example system 100. The system 100 includes a user device 102, a computing device 104, and one or more multiple printing devices 106 that are communicatively connected to a network 108, which may be or include the Internet. The user device 102 is a computing device of a user, who may also own, operate, or be responsible for the printing devices 106. The user device 102 may be a smartphone, tablet computing device, or other mobile computing device, as well as a desktop, laptop, or notebook computer, or another type of computing device. The computing device 104 may be a server computer that may provide a cloud computing service, and which is operated by or for the manufacturer of the printing devices 106. The printing devices 106 may each be a standalone printer, or an all-in-one (AIO) device that includes other functionality, such as scanning, copying, and faxing, in addition to printing functionality.

The user device 102 includes a display 110, input circuitry 112, an optical sensor 114, communication circuitry 116, and control circuitry 118. The display 110 is a flat-panel display (FPD) or another type of display on which information can be displayed to the user. The input circuitry 112 includes the electrical and other components by which the user can provide or enter input, and may be a touchscreen display integrated with the display 110. The optical sensor 114 may be a camera that is able to capture images, among other types of optical sensors. The optical sensor 114 is more generally a sensor that can electrically, electronically, or optically capture identifiers. The communication circuitry 116 of the user device 102 includes the electrical and other components to communicate with the computing device 104 via the network 108 in a wired or wireless manner.

The control circuitry 118 of the user device 102 may be considered as including a processor and memory, which may more generally be considered as a non-transitory computer-readable data storage medium. The processor and memory may be integrated within an application-specific integrated circuit (ASIC) in the case in which the processor is a special-purpose processor. The processor may instead be a general-purpose processor, such as a central processing unit (CPU), in which case the memory may be a separate semiconductor or other type of volatile or non-volatile memory. The control circuitry 118 can thus execute instructions or program code. The user device 102 can include other components as well, besides those depicted in the figure.

The computing device 104 includes communication circuitry 120, a processor 122, and a memory 124. The communication circuitry 120 includes the electrical and other components to communicate with the user device 102 and the printing device 106 via the network 108 in a wired or wireless manner. The processor 122 may be or include a CPU or other type of processor. The processor 122 and the memory 124 may be integrated within an ASIC. The memory 124 is more generally considered a non-transitory computer-readable data storage medium, and may be volatile or non-volatile. The memory 124 stores program code 126, which can be in the form of instructions, and which is executable by the processor 122. The computing device 104 can include other components as well, besides those depicted in the figure.

Each printing device 106 includes communication circuitry 128, printing hardware 130, and control circuitry 132. The communication circuitry 128 includes the electrical and other components to communicate with the computing device 104 via the network 108 in a wired or wireless manner. The printing hardware 130 includes the electrical and electronic circuitry as well as the mechanical components by which a printing device 106 prints. For example, in the case of a laser printing device 106, the printing hardware 130 is laser printing hardware 130, whereas in the case of an inkjet printing device 106, the printing hardware 130 is inkjet printing hardware 130.

The control circuitry 132 of the printing device 106 may be considered as including a processor and memory, which may more generally be considered as non-transitory computer-readable data storage medium. The processor and memory may be integrated within an ASIC, or the processor may be a general-purpose processor, in which case the memory may be a separate semiconductor or other type of memory. The control circuitry 132 can execute instructions or program code. Each printing device 106 can include other components as well, besides those depicted in the figure.

A consumable item 134 is enclosed within packaging 136, such as a box or other type of packaging. An identifier 138 of the consumable item 134 is printed or otherwise integrated on the packaging 136, and is visible without having to open the packaging 136. The identifier 138 may be in the form of a quick response (QR) code or other type of two-dimensional (2D) or one-dimensional (1D) barcode, or other type of optically scannable or readable code. The identifier 138 can be optically captured by the optical sensor 114 of the user device 102. In another implementation, the identifier 138 may be an electrically or electronically readable code that can be optically captured by the sensor 114 in the case in which the sensor 114 is not an optical sensor. For example, the identifier 138 may be a radio frequency identifier (RFID), a near-field communication (NFC) tag, or a Bluetooth low energy (BLE) identifier, among other types of identifiers.

The consumable item 134 itself also includes an identifier 140 of the consumable item, which be in the form of a security-hardened integrated circuit (IC), a RFID, a NFC tag, a BLE identifier, or other electronically or electrically readable code on or within the enclosure of the consumable item 134. The identifiers 138 and 140 match one another, in that both identify the consumable item 134, and may be identical in the information they encode in this respect. Upon removal of the consumable item 134 from the packaging 136, the consumable item 134 can be installed within a printing device 106 for the printing hardware 130 thereof to use for printing. The identifier 140 can be electrically read or retrieved by the control circuitry 132 of the printing device 106 when the consumable item 134 is installed within the device 106. In another implementation, the identifier 138 may not be present, such that the sensor 114 and the control circuitry 132 electrically read the same identifier 140.

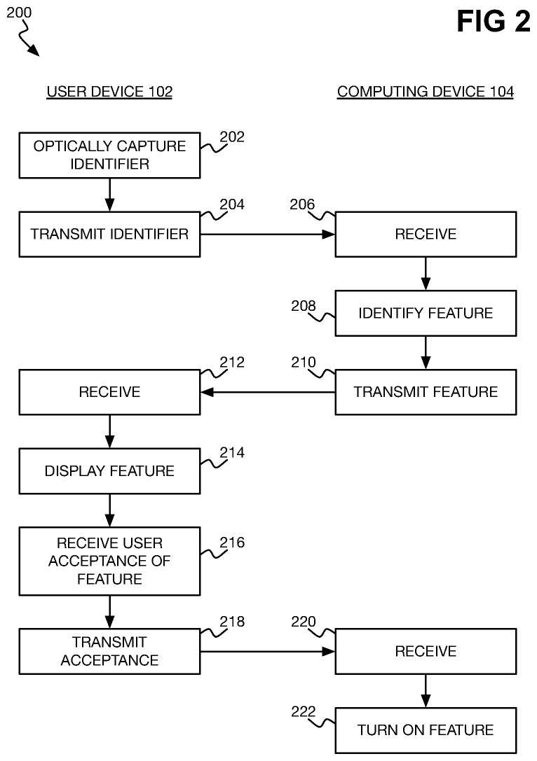

FIG. 2 shows an example method 200 for turning on a feature associated with a consumable item 134 for a printing device 106. The parts of the method 200 in the left column are performed by the user device 102, such as by the control circuitry 118 thereof, and the parts in the right column are performed by the computing device 104, such as by the processor 122 executing the program code 126 stored on the memory 124. The parts of the method 200 in the right column thus can be implemented as the memory 124 or other non-transitory computer-readable data storage medium storing the program code 126 that is executable by the processor 122. The method 200 is described in relation to the sensor 114 being an optical sensor and there being two identifiers 138 and 140, but is also applicable to the sensor 114 not being an optical sensor and/or there being just one identifier 140, as has been described.

The user device 102 optically captures the identifier 138 on the packaging 136 of the consumable item 134 via its optical sensor 114 (202). For example, the optical sensor 114 may capture an image of a portion of the packaging including the identifier 138, and the control circuitry 118 may then identify the identifier 138 within the captured image. The identifier 138 may be optically captured prior to user purchase or acquisition of the consumable item 134 or afterwards. The user device 102, via the communication circuitry 116, transmits the identifier 138 over the network 108 to the computing device 104 (204), which accordingly receives the identifier 138 (206).

The computing device 104 identifies a feature associated with the consumable item 134 based on the received identifier 138 (208). As noted, the feature may be associated with the consumable item 134 in that the feature extends the functionality of the item 134 when installed within and during usage by a printing device 106. For example, the feature may be a high-quality printing mode that is available when printing with the consumable item 134, or a toner- or ink-saving printing mode that is available when printing with the item 134. In this respect, the feature may be used just with the consumable item 134; once the useful remaining life of the item 134 is exhausted and the consumable item 134 has been removed from the printing device 106, the feature is no longer available.

As another example, the feature may be a specified number of pages that can be printed using the consumable item 134. The consumable item 134 may have a maximum number of pages that can be printed with the item 134. As such, the user may select a lower number of pages to use to print with the consumable item 134. This can likely result in a lower cost of the consumable item 134, in the case in which the identifier 138 is captured before user purchase of the item 134. The feature associated with the consumable item 134 can be any other type of feature that extends the functionality of the item 134 when installed within a printing device 106 as well.

The feature may instead be associated with the consumable item 134 in that the feature extends the functionality of the printing devices 106 with which the consumable item 134 may be compatible, regardless of whether the item 134 is installed in any particular device 106, as has also been noted. For example, the feature may be a new print quality mode that is not currently available at the printing devices 106, but which the devices 106 can be firmware-updated in the field to employ. In this respect, the feature once turned on can remain enabled even when the consumable item 134 has become exhausted of its remaining useful life. Furthermore, the feature may not be dependent on initial installation of the consumable item 134 within any printing device 106, but become available as soon as the feature is accepted by the user.

The computing device 104 can identify the feature in a number of different ways. The user of the user device 102 may be known. For example, the user may use an app running on the user device 102 to transmit the identifier 138 to the computing device 104. The user may be logged into an associated user account with the app, and the identity of the user transmitted along with the identifier 138 to the computing device 104. The computing device 104 can look up the user account to identify the printing devices 106 associated with the user account. The computing device 104 can then identify the features that are compatible with these printing devices 106, and that the user has not yet enabled at the devices 106.

As another example, the consumable item 134 may be compatible with a class of different printing devices 106. This class of printing devices 106 may have a common set of features that can be enabled, in relation to the consumable item 134 if installed in such a printing device 106, and/or regardless of whether the item 134 is installed in such a device 106. The computing device 104 thus can identify this common set of features to provide to the user of the user device 102, even if the user is unknown to the computing device 104 and to the manufacturer of the consumable item 134.

The computing device 104, via the communication circuitry 120, transmits over the network 108 the identified feature to the user device 102 (210), which accordingly receives the feature (212). The user device 102 displays the feature to the user on the display 110 (214). The feature may be displayed using augmented reality (AR), for instance. That is, a summary of the feature, and its cost, may be displayed as if it were part of the packaging 136 of the consumable item 134. The user may then be able to select this AR representation of the feature to cause the user device 102 to display further information regarding the feature in a non-AR manner, and present the user with the ability to accept (e.g., purchase) the feature.

Assuming that the user accepts the feature, therefore, the user device 102 receives such feature acceptance via the input circuitry 112 (216). Purchase of the offer may entail acceptance of the offer, but in another example the offer can be accepted without requiring any purchase thereof (i.e., in a non-retail or non-business scenario). The user device 102 then transmits, via the communication circuitry 116, the user acceptance of the feature over the network 108 to the computing device 104 (218), which receives the acceptance (220). The computing device 104 accordingly turns on the feature such that the feature is enabled at one or multiple printing devices 106, as is now described in detail.

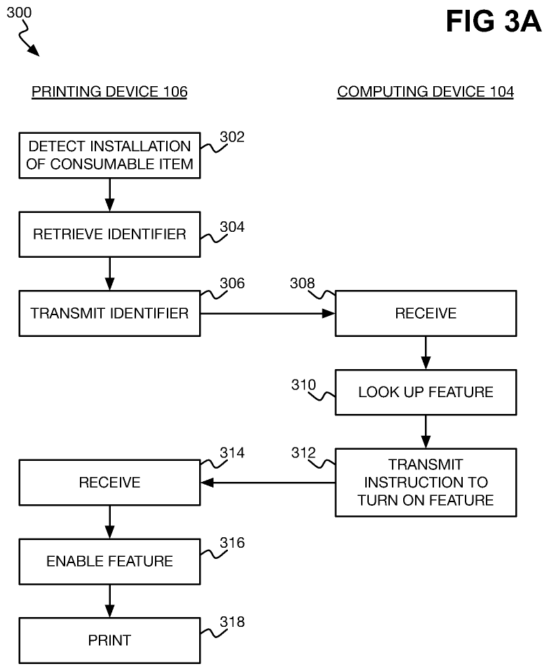

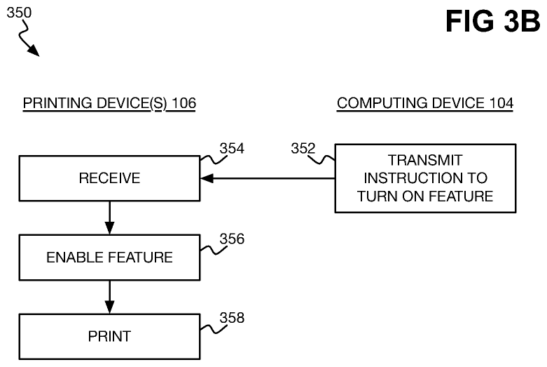

FIG. 3A shows an example method 300 for enabling the feature at the printing device 106 in which the consumable item 134 is installed, when the consumable item 134 is installed in the device 106. The parts of the method 300 in the left column are performed by the printing device 106 in which the consumable item 134 is installed, such as by the control circuitry 132 thereof, and the parts of the right column are performed by the computing device 104, such as by the processor 122 executing the program code 126 stored on the memory 124. The parts of the method 200 in the right column can thus be implemented as the memory 124 or other non-transitory computer-readable data storage medium storing program code 126 executable by the processor 122.

Upon replacement of an existing consumable item within the printing device 106 with the consumable item 134, the printing device 106 detects installation of the item 134 within the device 106 (302). The printing device 106 retrieves (e.g., electrically reads) the identifier 140 that is on or integrated within the consumable item 134 itself (304). The printing device 106, via the communication circuitry 128, transmits the identifier 140 over the network 108 to the computing device 104 (306), which accordingly receives the identifier 140 (308).

The computing device 104 looks up the feature that was previously associated with the consumable item 134 based on the received identifier 140 (310). For example, when turning on the feature in the method 200, the computing device 104 may have stored information regarding the feature, and linked the feature to the consumable item 134 via the identifiers 138 and 140 of the consumable item 134. Therefore, upon receipt of the identifier 140 from the printing device 106 in which the consumable item 134 has been installed, the computing device 104 can again identify the feature.

The computing device 104, via the communication circuitry 120, transmits an instruction over the network 108 to the printing device 106 to turn on the feature (312). The printing device 106 accordingly receives this instruction (314), and enables the feature (316). The printing device 106 can subsequently print using the installed consumable item 134 with the enabled feature (318). As noted, the feature may be tied to the consumable item 134. Therefore, upon the consumable item 134 no longer being used in the printing device 106, such as due to replacement of the item 134 with a different consumable item due to the exhaustion of the useful life of the consumable item 134, the feature is no longer usable and is disabled.

FIG. 3B shows another example method 350 for enabling the feature at one or multiple selected printing devices 106, regardless of whether the consumable item 134 has been installed in any such device 106. The parts of the method 350 in the left column are performed by each such selected printing device 106 in which the consumable item 134, such as by the control circuitry 132 thereof, and the parts of the right column are performed by the computing device 104, such as by the processor 122 executing the program code 126 stored on the memory 124. The parts in the right column can be implemented as the memory 124 or other non-transitory computer-readable data storage medium storing program code 126 executable by the processor 122.

As to which printing devices 106 that are subject to the method 350, the user device 102, when receiving user acceptance of the feature in the method 200, may also receive selection of the printing devices 106 on which the feature is to be enabled, and transmit identification of these selected printing devices 106 to the computing device 104. For example, the printing devices 106 may be associated with the user account of the user on an app running on the user device 102. The user thus may select on which printing device 106 or devices 106 the feature is to be enabled. In this respect, a different feature or features may be enabled on different printing devices 106. When identifying the features in the method 200, the computing device 104 may therefore identify the printing devices 106 associated with the user account in order to identify which features are compatible with each such device 106.

The computing device 104, via the communication circuitry 120, transmits over the network 108 an instruction to each selected printing device 106 to turn on the feature in question (352). The computing device 104 may transmit this instruction immediately upon receiving user acceptance in the method 200, as opposed to waiting for the consumable item 134 to be installed within a printing device 106 as in the method 300. That is, the method 350 does not have to be predicated on installation of the consumable item 134 in a printing device 106, in contradistinction to the method 300.

Each printing device 106, via its communication circuitry 128, accordingly receives the instruction to turn on a feature (354). Each printing device 106 enables the feature that it has been instructed to turn on (356). Each printing device 106 can subsequently print with the enabled featured (358). In this respect, a printing device 106 can print with the enabled feature regardless of whether the consumable item 134 is installed in the device 106, or a consumable item other than the consumable item 134 is installed in the printing device 106.

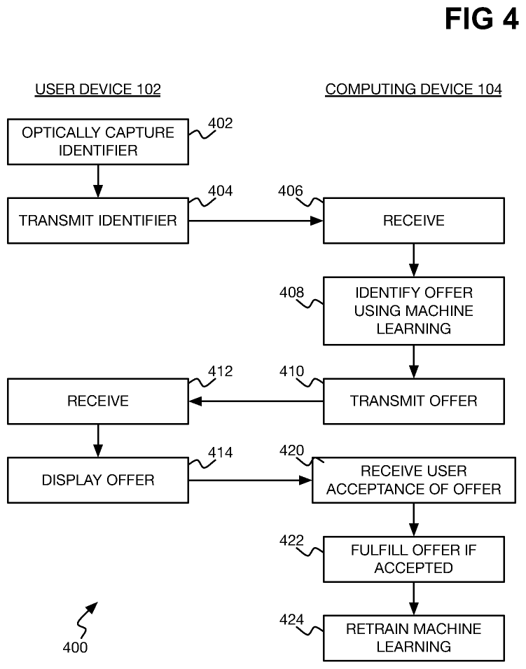

FIG. 4 shows an example method 400 for fulling an offer associated with a consumable item 134 for a printing device 106. The parts of the method 400 in the left column are performed by the user device 102, such as by the control circuitry 118 thereof, and the parts in the right column are performed by the computing device 104, such as by the processor 122 executing the program code 126 stored on the memory 124. The parts of the method 400 in the right column thus can be implemented as the memory 124 or other non-transitory computer-readable data storage medium storing the program code 126 that is executable by the processor 122. The method 400 is described in relation to the sensor 114 being an optical sensor and there being two identifiers 138 and 140, but is also applicable to the sensor 114 not being an optical sensor and/or there being just one identifier 140, as has been described.

The user device 102 optically captures the identifier 138 on the packaging 136 of the consumable item 134 via its optical sensor 114 (402). For example, the optical sensor 114 may capture an image of a portion of the packaging including the identifier 138, and the control circuitry 118 may then identify the identifier 138 within the captured image. The identifier 138 may be optically captured prior to sale of (i.e., user purchase of) the consumable item 134. The user device 102, via the communication circuitry 116, transmits the identifier 138 over the network 108 to the computing device 104 (404), which accordingly receives the identifier 138 (406).

The computing device 104 identifies an offer associated with the consumable item 134 based on the received identifier 138 (208). The offer may be for a discount that is fulfilled if the offer is accepted and the user ultimately purchases the consumable item 134 (i.e., at time of sale of the item 134). The offer may be identified using machine learning based on one or multiple factors. Such factors can include the identifier of the consumable item 134 itself, the location of the user device 102 and thus the location at which the user is considering purchase of the item 134; a type of or the actual printing device 106 in which the consumable item 134 can be installed; and an identify of the user of the user device 102.

As to the identifier of the consumable item 134, this factor can be used in identifying the offer, such as determining how much of a discount to offer, in that different types of consumable items 134 may be provided with different discounts. For example, a slower selling consumable item 134 may be provided with a higher discount than a lower selling consumable item 134. The location of the user device 102, and thus the location at which the user is considering purchase of the consumable item 134, may be determined based on the network address of the user device 102 included within communication to the computing device 104, or in another manner. This factor can be used in identifying the offer in that different geographic regions may be provided with different discounts for the same consumable item 134.

As to the type (or class) of printing device 106 in which the consumable item 134 can be installed, this information is known to the manufacturer, and thus to the computing device 104, because different consumable items 134 are compatible with different printing devices 106. This factor can be used in identifying the offer in that the offer may be contingent on the type or class of the printing device 106 in which the consumable item 134 can be used. As one example, if the manufacturer has a high profit margin on the type or class of printing device 106, then the discount accorded to the consumable item 134 may be greater than if the manufacturer has a low profit margin on the type or class of printing device.

As to the actual printing device 106 in which the consumable item 134 can (and likely will) be installed, this information may be determined if the user has logged into a user account in an app running on the user device 102, where the one or multiple printing devices 106 of the user are indicated on the user account as well. The computing device 104 can then identify which of these printing devices 106 are compatible with the consumable item 134. This factor can then be used in identifying the offer. As one example, if the consumable item 134 is replaced frequently within the printing device 106, then a greater discount may be accorded as a way to reward the user.

As to the identity of the user of the user device 102, this information can similarly be determined if the user has logged into a user account in an app running on the user device 102. This factor can then be used in identifying the offer. As one example, if the user has frequently purchased consumable items like the consumable item 134, then a greater discount may be accorded as a way to reward the user. By comparison, as another example, if the user has never purchased consumable litem like the consumable item 134, then a greater discount may still be accorded as a way to entice the user to make such a purchase.

The computing device 104 can identify the offer using machine learning based on the aforementioned and/or other factors. The machine learning model that is used may be trained to identify the lowest discount that will likely sway a user to purchase the consumable item 134. Therefore, as different users purchase (or do not purchase) different consumable items upon being provided with different offers, the machine learning model will become more accurate in identifying the lowest offer that will result in the user purchasing the consumable item 134.

The computing device 104, via the communication circuitry 120, transmits over the network 108 the identified offer to the user device 102 (410), which accordingly receives the offer (412). The user device 102 displays the offer to the user on the display 110 (414). The offer may be displayed using AR for instance. That is, the offer may be displayed as if it were part of the packaging 136 of the consumable item 134. The user may then be able to select this AR representation of the feature to cause the user device 102 to display further information regarding the offer in a non-AR manner. For example, a QR code or other code may be displayed for the user to show at checkout (i.e., at time of sale or purchase of the consumable item 134) to receive the accorded discount.

Assuming the offer is accepted by the user, in that the user purchases the consumable item 134 with the received offer, the computing device 104 receives indication as to such user acceptance of the offer (420). For example, the QR code or other code that encodes the offer may be unique to the offer. Therefore, if the code is used at time of sale to receive the discount on purchase of the consumable item 134, the computing device 104 ultimately receives indication from the merchant at which the user used the code. The computing device 104 thus effectively fulfills the offer if accepted (422), insofar as the manufacturer that is operating the computing device 104 or on whose behalf the computing device 104 is being operated will reimburse the merchant the amount of the discount accorded by the offer.

The computing device 104 can periodically retrain the machine learning used to identify offers for consumable items based on whether provided offers have been accepted or declined (424). An offer associated with a consumable item 134 is accepted if the offer is used when purchasing the consumable item 134, and is otherwise declined. An offer may have a limited period of time before it expires, and the manufacturer may receive indication from merchants as to which offers were accepted in a given time period. For an offer expiring in such a given time period, if the manufacturer has not reported that the offer was used, then the computing device 104 can conclude that the offer was effectively declined.

Techniques have been described herein for features and offers associated with printing device consumable items. Such features can be a way to extend the functionality of consumable items and/or printing devices, and such offers can be a way to compel purchase of consumable items. The features and offers may be displayed using AR, as if the features and offers were printed on the packaging of the consumable items themselves.

We claim:

1. A non-transitory computer-readable data storage medium storing program code executable by a processor to perform processing comprising:
receiving, from a user device, an identifier of a printing device consumable item captured by the user device;
identifying a feature associated with the consumable item or an offer associated with the consumable item;
transmitting, to the user device, the feature or the offer for display on the user device;
receiving acceptance of the feature or the offer; and
in response to receiving the acceptance of the feature or the offer, turning on the feature or fulfilling the offer.

2. The non-transitory computer-readable data storage medium of claim 1, wherein identifying the feature or the offer comprises identifying the feature,
wherein receiving the acceptance of the feature or the offer comprises receiving the acceptance of the feature,
and wherein turning on the feature or fulfilling the offer comprises turning on the feature.

3. The non-transitory computer-readable data storage medium of claim 2, wherein turning on the feature comprises:
receiving, from a printing device associated with a user of the user device, the identifier of the consumable item, indicating that the consumable item has been installed within the printing device;
in response to receiving the identifier, identifying the feature associated with the consumable item based on the identifier; and
transmitting, to the printing device, an instruction to enable the feature on the printing device.

4. The non-transitory computer-readable data storage medium of claim 2, wherein identifying the feature comprises identifying one or multiple printing devices associated with a user account of a user of the user device and in which the consumable item can be installed,
wherein receiving the acceptance of the feature comprises receiving, from the user device, identification of one or multiple user-selected printing devices on which the feature is to be enabled, from the printing devices associated with the user account,
and wherein turning on the feature comprises transmitting, to each user-selected printing device, an instruction to enable the feature on the user-selected printing device.

5. The non-transitory computer-readable data storage medium of claim 2, wherein the feature is associated with the consumable item in that the feature extends functionality of the consumable item when the consumable item is installed within a printing device.

6. The non-transitory computer-readable data storage medium of claim 2, wherein the feature is associated with the consumable item in that the feature extends functionality of a printing device.

7. The non-transitory computer-readable data storage medium of claim 1, wherein identifying the feature or the offer comprises identifying the offer,
wherein receiving the acceptance of the feature or the offer comprises receiving the acceptance of the offer,
and wherein turning on the feature or fulfilling the offer comprises fulfilling the offer.

8. The non-transitory computer-readable data storage medium of claim 7, wherein the identifier of the consumable item is received from the user device and the offer is transmitted to the user device prior to sale of the consumable item.

9. The non-transitory computer-readable data storage medium of claim 7, wherein identifying the offer comprises identifying the offer based on one or multiple of: the identifier of the consumable item; a location of the user device; a printing device in which the consumable item can be installed; and an identity of a user of the user device.

10. The non-transitory computer-readable data storage medium of claim 9, wherein identifying the offer comprises identifying the offer using machine learning,
and wherein the processing further comprises retraining the machine learning based on whether the offer was accepted or declined.

11. A user device comprising:
a display;
input circuitry;
a sensor;
communication circuitry to communicate with a computing device; and
control circuitry to:
capture an identifier of a printing device consumable item via the sensor;
transmit the identifier to the computing device;
receive a feature associated with the consumable item or an offer associated with the consumable item from the computing device; and
display the feature or the offer on the display.

12. The user device of claim 11, wherein the sensor comprises a camera to capture an image of packaging of the consumable item that includes the identifier,
and wherein the control circuitry is to display the feature or the offer on the display by displaying the feature or the offer on the image of the package using augmented reality (AR).

13. A printing device comprising:
communication circuitry to communicate with a computing device;
printing hardware;
control circuitry to:
detect installation of a consumable item that the printing hardware uses for printing;
retrieve an identifier of the consumable item from the consumable item;
transmit the identifier to the computing device;
receive, from the computing device, an instruction to turn on a feature associated with the consumable item;
enable the feature; and
cause the printing hardware to print using the consumable item with the enabled feature.

14. The printing device of claim 13, wherein the feature is associated with the consumable item in that the feature extends functionality of the consumable item during usage of the consumable item by the printing hardware when printing.

15. The printing device of claim 13, wherein the feature is associated with the consumable item in that the feature extends functionality of the printing device during usage of the consumable item by the printing hardware when printing.
